(19) United States
(12) Patent Application Publication
(10) Pub. No.: US 2015/0379173 A1
(43) Pub. Date: Dec. 31, 2015

(54) METHOD FOR PROCESSING A SET OF DATA TO BE USED SUBSEQUENTLY WITH A VIEW TO GRAPHICALLY GENERATING AN ELECTRICAL DIAGRAM OF AN ELECTRICAL SYSTEM

(71) Applicant: RENAULT, Boulogne Billancourt (FR)

(72) Inventor: Nouman ZOUKARI, Les Ulis (FR)

(73) Assignee: RENAULT S.A.S, Boulogne Billancourt (FR)

(21) Appl. No.: 14/769,189

(22) PCT Filed: Feb. 28, 2014
(86) PCT No.: PCT/FR2014/050445

§ 371 Date: Aug. 20, 2015

(30) Foreign Application Priority Data
Mar. 4, 2013 (FR) 1351903

(51) Int. Cl. G06F 17/50; G06T 11/20

(52) U.S. Cl. CPC G06F 17/509; G06T 11/206

(57) ABSTRACT

A processing method that makes it possible to process a set of data to be used subsequently to graphically generate an electrical diagram of an electrical system, for example an electrical system for a motor vehicle. The method includes transmission of a model from a database to a computer, the model including a list of identifiers of parts of the electrical system, and, for each part identifier, a position of the part on the electrical diagram to be generated. After having determined a configuration of the electrical diagram and association between the electrical diagram parts and connectors, the computer determines a topology of the electrical diagram to be generated, the topology including connecting elements, each connecting element connecting at least two connectors.

### TECHNICAL FIELD OF THE INVENTION

The invention relates to the field of the generation of electrical diagrams.

The subject of the invention is more particularly a method intended to process data upstream of the plotting of an electrical diagram with a view to the carrying out of said plotting.

### PRIOR ART

In the automotive field, it is necessary to generate electrical diagrams of the various electrical systems with which a vehicle is equipped. These electrical diagrams are intended to be used within the framework of the after-sales service to allow an operator intervention on the vehicle. In order to optimize the intervention time, the diagram must be clear and ergonomic for the operator tasked with said intervention.

The number of types of vehicles and associated electrical systems being significant, the phase of graphical generation of these diagrams takes an appreciable time.

### OBJECT OF THE INVENTION

The aim of the present invention is to propose a solution which remedies the drawbacks listed hereinabove.

This aim is addressed through a method for processing a set of data intended to be used subsequently with a view to the graphical generation of an electrical diagram of an electrical system, for example of an electrical system for an automotive vehicle, said method comprising the following steps:
transmitting a model arising from a database to a computer, said model comprising a list of identifiers of components of the electrical system, and, for each component identifier, a position of said component on the electrical diagram to be generated,
determining, by the computer, a configuration of the electrical diagram to be generated, said configuration including a plurality of connectors,
associating, by the computer, with each component at least one connector of the plurality of connectors,
determining, by the computer, a topology of the electrical diagram to be generated, said topology comprising linking elements, each linking element linking at least two connectors.

Preferably, the configuration determined is chosen from among a plurality of configurations of the electrical diagram.

According to a particular implementation, the step of associating at least one connector with each component comprises a step of positioning one or more connectors on the basis of data arising from the topology determined and the model provided. For example the positioning, at the level of a component, of at least one of the connectors associated with one and the same linking element is carried out so as to minimize its length.

According to another example, a first linking element is associated with a first connector of a first component and with a second connector of a second component, and in that the positioning of the first connector at the level of the first component is carried out so that the distance, between a first point of attachment of the first connector to the first component and a second point of attachment of the second connector to the second component, is a minimum.

According to a particular mode of execution, a first linking element of a first weight is associated with a first connector of a first component and with a second connector of a second component, a second linking element of a second weight is associated with the first connector of the first component and with a third connector of a third component, and the positioning of the first connector is carried out so as to minimize the length of the linking element whose weight is the largest.

Advantageously, the method comprises a step of allotting a weight to each linking element, said allotted weight being equal to the number of ins-outs associated with the linking element, the number of ins-outs for each linking element being contained in the determined topology of the electrical diagram.

For example, two linking elements of the electrical diagram share a branch in common, and the method comprises a step of positioning at least one union intended to link, via associated branches, at least three corresponding connectors.

Preferably, the union is positioned so as to decrease the length of the branches associated with said union.

The invention also relates to a method of graphical generation of an electrical diagram, comprising:
a step of implementing the processing method according to one such as described,
a step of graphically generating the electrical diagram of the electrical system on the basis of the data arising from the processing method by transmission of these data to a drawing device, in particular a device for paper or digital printing in image form or in vector form.

The invention also relates to a computer program comprising a computer program code means suitable for carrying out the steps of a method such as described, when the program is executed by a computer.

### SUMMARY DESCRIPTION OF THE DRAWINGS

Other advantages and characteristics will emerge more clearly from the description which follows of particular embodiments of the invention that are given by way of nonlimiting examples and represented in the appended drawings, in which:

FIG. 1 schematically represents steps of a processing method according to a mode of execution of the invention,

FIGS. 2 to 6 are views graphically representing digital data at various junctures of the processing method,

FIG. 7 illustrates a particular mode of execution of the steps of the processing method.

### DESCRIPTION OF PREFERENTIAL MODES OF THE INVENTION

In the present description, “electrical system” is understood to mean, for example, a system intended to provide an electrical function, in particular of a vehicle. An electrical system can therefore be chosen, by way of nonlimiting example, from the following list: an air-conditioning, an electric window, a display, an electric parking brake, etc. An electrical system can comprise a plurality of components associated with a list of electrical connections in the form of ins-outs, also called inputs-outputs, defining the interconnections of the components via connectors. Typically a component is able to generate a predetermined function within the system concerned, it may entail a computer, a sensor, etc. The ins-outs can participate in the definition of the connectors intended to be associated with the components and of linking elements intended to interlink the connectors. In fact, the ins-outs describe solely the connections between the components used on an electrical system, in particular through the connectors and unions.

Although the automotive field is given as example, the problematic issue is the same in any type of electrical diagram to be generated graphically, in particular for diagrams relating to electrical cabinets, electro-domestic appliances, etc. The invention is therefore not limited to electrical systems for automotive vehicles.

As illustrated in FIG. 1, the method for processing a set of data intended to be used subsequently with a view to the graphical generation of an electrical diagram of an electrical system can comprise a step E1 in which a model arising from a database is transmitted to a computer. The model (template) comprises a list of identifiers of components of the electrical system, for example of an electrical system for automotive vehicle, and, for each component identifier, a position of the component on the electrical diagram to be generated. In fact, what is transmitted here can comprise records of the database, also called a library, whose fields are respectively representative of an object corresponding to a component identifier and of an object comprising positioning coordinates. At this juncture, these records make it possible to define each electrical function by a set of components able to ensure the electrical function in question (for example, there will be a list of components associated with an airbag system or else a list of components related to an air-conditioning system). These positioning coordinates can be associated with a benchmark corresponding to a page on which the electrical diagram of the electrical system concerned will have to be plotted. Preferably, the model comprises solely identifiers forming part of the electrical diagram of the electrical system concerned and the positions of these components on the page of the electrical diagram.

The model is in general created by a manager of the library with the agreement and the validation of the manager of the function of the electrical system.

The method furthermore comprises a step E2 in which a configuration of the electrical diagram to be generated is determined by the computer. The configuration includes a plurality of connectors. The configuration of the electrical diagram can be determined on the basis of the database which comprises for example, for the electrical system concerned, a list of connectors and their associations with the components. In fact, for the electrical system, the list of components can be supplemented with the associated connectors and the list of ins-outs according to a preprocessing in the database. According to a particular example, the database comprises records associating identifiers of connectors with identifiers of components according to the following relations: a given connector identifier is associated with a single component identifier, a component identifier can be associated with one or more different connector identifiers. Preferably, the configuration determined is chosen from among a plurality of configurations of the electrical diagram. In fact, two electrical systems of the same nature may have a different configuration, that is to say comprise one and the same list of components but lists of different connectors and/or ins-outs. For example, a bottom-of-the-range air-conditioning and a top-of-the-range air-conditioning are two electrical systems of the same nature but of different configurations, thus they may comprise the same components positioned at the same locations, however the links between these components are different so that certain functionalities of the top-of-the-range air-conditioning are not activated in the bottom-of-the-range air-conditioning, stated otherwise these two levels of air-conditioning may be represented using the same model.

Once the connectors have been determined via the configuration, the method comprises a step of association E3, by the computer, of at least one connector of the plurality of connectors with each component. The result of the association may already be known, in this case the association is effected by simple reading in the database so as to determine the list of component/connector associations. Preferably, each connector of the plurality of connectors is associated with a component. This association also makes it possible, for example, to compute, or to determine, for each connector a point of attachment of the connector to its corresponding component, the coordinates of the points of attachment then being dependent on the position of the component arising from the model provided. Preferably, the database also comprises for each component a list of points of attachment each intended to cooperate with a connector. According to a particular example, the database comprises records associating identifiers of components with positions (or coordinates) of points of attachment according to the following relation: a given component identifier can be associated with one or more different positions (or coordinates). If the database does not comprise any such records, these positions of points of attachment can be computed in particular on the basis of the position of said component arising from the model. Initially, it is possible to allot in an unordered manner each connector of each component to a point of attachment. An optimization allowing best positioning of the connectors will be seen subsequently. Such an association can be determined on the basis of records of the database each comprising: the reference of the electrical diagram or more precisely the configuration of the electrical diagram to be generated, the identifier of the component, and a connector identifier. The cross-referencing of these records with the data of the model make it possible to define at least partially and digitally the electrical diagram to be generated.

Finally, the method can comprise a step of determination E4, by the computer, of a topology of the electrical diagram to be generated, said topology comprising linking elements, each linking element linking at least two connectors, preferably associated with distinct components. This step E4 makes it possible to determine how connectors are linked together. The topology may, for example, be extracted from the database as a function of the configuration determined, in particular on the basis of the ins-outs. Stated otherwise, the topology can be determined on the basis of records of the database each comprising two identifiers of connectors and a linking element identifier. The cross-referencing of these records with the data of the model and the records relating to the associations between the components and the connectors make it possible to digitally supplement the electrical diagram to be generated.

Thus, the method can be implemented by a computer interfaced with at least one storage medium comprising the database. The computer is then able to extract data from the database and/or to inject said data by creation or modification.

Moreover, the electrical diagram can be chosen from among a set of elements, each element being representative of an electrical diagram. In this case the processing method can comprise a step of determining an identifier relating to the element to be processed from among the set, this identifier then making it possible to choose the appropriate model to be processed.

It is understood that the data processed by the computer in the course of the method can be thus processed so as to constitute a digital object comprising all the characteristics of an electrical diagram to be generated. Once the digital object has been constituted, the method can comprise a step of storing the digital object in the database. The advantage of such a digital object is that it is easy to manipulate in terms of memory and to modify if one wishes to improve it.

Thus, the list of identifiers of components and their positionings, the plurality of connectors, the association of the connectors with the components and the topology of the electrical diagram can be attributes added to the digital object. Stated otherwise, the method can comprise a step of forming a digital object comprising the attributes mentioned hereinabove. The aim being that at the end of the method, the digital object can be drawn while limiting the alterations which generate time loss. Indeed, modification of a graphic involves a validation process of non-negligible duration. Stated otherwise, advantageously, the steps of the processing method are digital only steps and carried out by the computer, in particular steps of alteration of the future graphical plot of the electrical diagram. An alteration step in particular can be an alteration of the position of the connectors at the levels of their associated components so as to avoid the crossover of at least two linking elements on the future graphical electrical diagram.

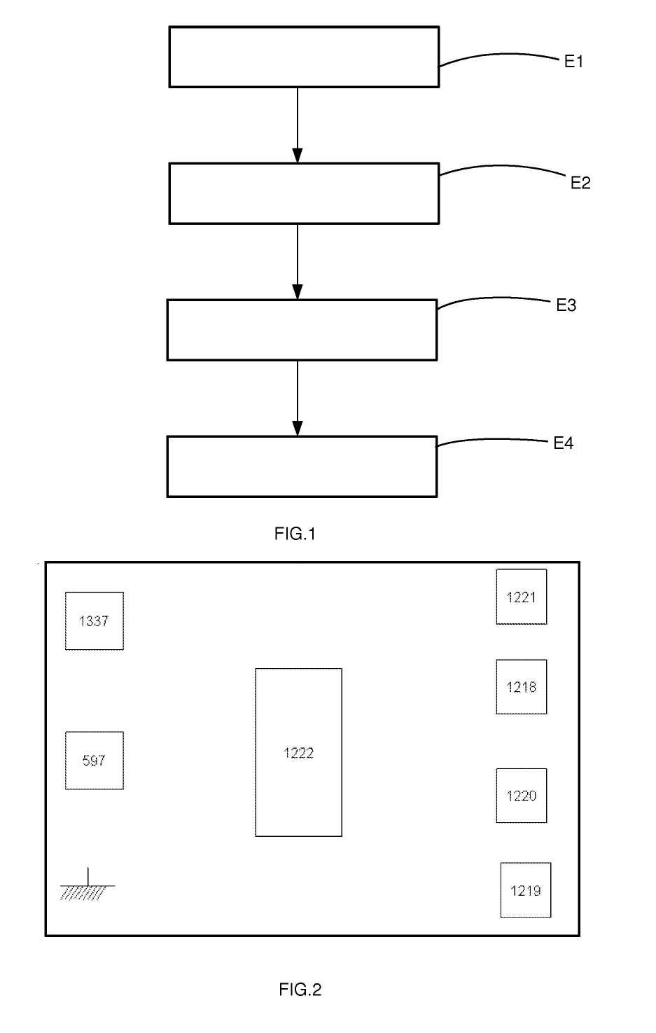

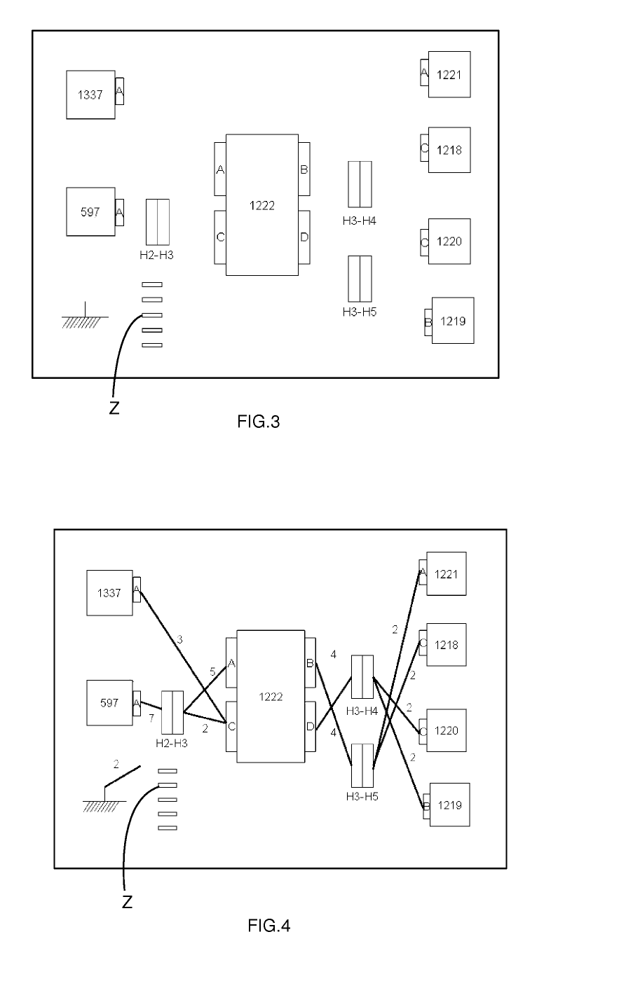

In order to illustrate the processing of the data by the method described, FIG. 2 shows a representation of what can be obtained graphically on the basis of the step in which the model is transmitted. In this FIG. 2, the components are positioned and represented by blocks tagged by their identifiers respectively 1218, 1219, 1220, 1221, 1222, 1337 and 597. Moreover, Figure illustrates the cross-referencing of the results of the step of provision of the model with the data making it possible to determine the configuration and the component/connector associations. Seen therein is the association of the connectors (denoted A, B, C, D for the needs of the example) with the components 1218, 1219, 1220, 1221, 1222, 1337 and 597. Moreover, apparent in FIG. 3 are unions H2-H3, H3-H4 and H3-H5 which allow certain linking elements to have common parts and splices Z which make it possible to lengthen the linking elements. When the desired topology is applied, a correspondence table illustrated by the diagram of FIG. 4 is obtained. In FIG. 4, the positioning of the various elements is relatively arbitrary, that is to say that although functional it is not optimized ergonomically. It follows from this that an electrical diagram in this form would still be difficult to read on account of the crossovers of certain constituent linking elements. At the juncture of FIG. 4, the positioning is only in the database and not graphical: the connectors A, B, C, and D are simply said to be tied to the component 1222.

Hence, in an optional but preferential manner, still upstream of the graphical production of the electrical diagram, we shall seek to determine, via the processing method, improved positioning parameters for the connectors and/or unions so that the most readable possible electrical diagram can be drawn directly by utilizing these data. The problematic issue of the readability of the electrical diagram exhibits a significant impact for after-sales service workshops. Stated otherwise, the final coordinates of the connectors depend on the topology determined. It is in particular possible to consider that the coordinates of the connectors in the benchmark of the page intended to receive the plot of the electrical diagram are determined on the basis of the topology of the electrical diagram so as to minimize the number of crossover of linking elements when plotting the electrical diagram.

Thus, it may be considered that the digital object mentioned hereinabove will be modified/altered so as to anticipate the future graphical placement of the constituent elements of the electrical diagram.

Hence, the step of associating E3 at least one connector with each component can comprise a step of positioning one or more connectors on the basis of data arising from the topology determined and of the model provided. For example, the data arising from the topology making it possible to place a connector relate to at least one linking element length, that is to say a distance between two objects in particular two connectors or components linked by the linking element, and/or to weights allotted to at least two linking elements. In fact the weight is associated with a linking element linking the two connectors or components.

In particular, according to a first placement rule, the positioning, at the level of a component, of at least one of the connectors associated with one and the same linking element is carried out so as to minimize its length, that is to say the distance between the two objects to be connected. Stated otherwise, a first linking element can be associated with a first connector of a first component and with a second connector of a second component, and the positioning of the first connector at the level of the first component can be carried out so that the distance, between a first point of attachment of the first connector to the first component and a second point of attachment of the second connector to the second component, is a minimum. The points of attachment can have predetermined coordinates, for example stored in the database as mentioned previously, or determinable for example by computation in the sense that the only constraint on the connector is of being, on the future graphic to be produced, in contact with its associated component.

According to a second rule which may or may not be combined with the first rule and which exhibits the advantage of resolving certain ambiguities, each linking element is associated with a weight (in FIGS. 4 and 5, the weights correspond to the digits adjacent to the linking elements linking two connectors or a union and a connector), in particular a weight dependent on a number of ins-outs between two connectors. Hence, the positioning of one or more connectors can depend on the values of the weights of at least two linking elements. According to a preferred example of implementation of the second rule, a first linking element of a first weight can be associated with a first connector of a first component and with a second connector of a second component, and a second linking element of a second weight is associated with the first connector of the first component and with a third connector of a third component, so that the positioning of the first connector is carried out so as to minimize the length of the linking element whose weight is the largest. In this example, the first, second and third components are, preferably, distinct. It results from this second rule that the processing method can comprise a step of allotting a weight to each linking element, said allotted weight being equal to the number of ins-outs associated with said linking element, the number of ins-outs for each linking element being contained in the determined topology of the electrical diagram.

According to a particular implementation of the second rule, the method comprises a step of ranking the linking elements as a function of their weights, and the step of positioning the connectors is carried out according to the order of the ranking. For example, the positioning of at least one of the connectors associated with a first linking element present in the ranking onward of the second position of the ranking is carried out while taking into account the positioning already carried out of one or more connectors associated with at least one second linking element whose position in the ranking is higher than that of the first linking element. The ranking is optional since it is not necessary at this juncture, indeed, it entails quite simply taking the list of the connectors that are related to the diagram in question and are available in the database (the list being sorted in the increasing order of the identifiers of the associated components) and undertaking the processing in the following manner: for each triplet (Connector_1 of Component_1, Connector_2 of Component_2, Weight), and by using the “Distances” between the various “points of attachment” of Component_1 and Component_2 in the database, there is computed the “best” connector to be positioned on each “point of attachment” according to the two aforementioned rules. In case of conflict between two connectors of the list (that is to say: two connectors at the same point of attachment), it is the first connector positioned that will get the place, the second connector will in this case be placed in the second best place according to the same rules.

The first and/or the second rule results in a graphical diagram whose plot is clearer and more readable. Typically, the application of the first and second rules to the connectors A and C of the component 1222 makes it possible to pass from the positioning of FIG. 4 to that of FIG. 5. These two rules taken alone or in combination make it possible to deal with a problematic issue of economies of cycles of the computer.

The person skilled in the art will be able to determine other types of rankings making it possible to generate a definitive and optimal positioning of the connectors at the level of the components in such a way as to: limit in a general manner the aggregate length of the linking elements, avoid crossovers of linking elements, etc.

In an electrical diagram that it is sought to generate, the linking elements may all be distinct or share common parts. For example the linking elements can comprise unions H2-H3, H3-H4, H3-H5 (FIGS. 3 to 5) making it possible to fuse a part of at least two linking elements, as well as splices Z (FIGS. 3 to 5) making it possible to lengthen a linking element. The unions are advantageously processed according to the same rules as the components (a point of attachment of a union being situated in the middle of each left and right side). Concerning the splices, there is no specific processing since they will be positioned directly in the last step of the method directly on the graphic.

The presence of a union is decided by the person skilled in electronic electrical architecture and is not related to the number of connectors to be linked. In FIG. 4, two linking elements of the electrical diagram share a branch in common, and the method can comprise a step of positioning at least one union intended to link, via associated branches, at least three corresponding connectors. Hence, the various associated branches all converge toward the union so as to each be linked, on the one hand, to one of the connectors and, on the other hand, to the union. Preferably, this positioning is such that the length, in particular aggregate or average, of the branches associated with said union is a minimum or is decreased. When the electrical diagram comprises several unions, these can be positioned by applying the principles of the two rules given hereinabove. It is moreover by applying the first and second rules that the unions H3-H5 and H3-H4 have been repositioned from FIG. 4 to FIG. 5. Returning to the examples given hereinabove, a union can replace one of the connectors aimed at in the first and/or second rules, in particular replace the first connector (of course, in this case it is understood that the union is not associated with the first component but is for example intended to be linked by a corresponding linking element to the first connector of the first component).

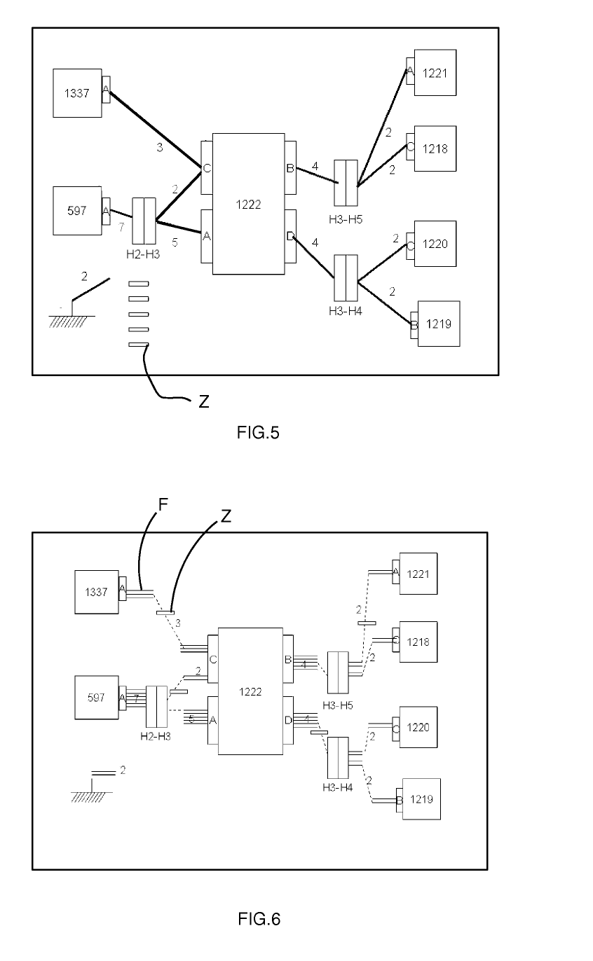

Moreover, as illustrated in FIG. 6, the processing method can comprise a step of characterizing the linking elements making it possible to generate a wire F for each signal traveling in all or part of a linking element. Each wire can be associated with a connection terminal, if appropriate, of a connector or of a union. Moreover, in this FIG. 6 the splices Z have also been placed in an apt manner.

It is understood from what has been stated hereinabove that the implementation of the processing method makes it possible thereafter to very rapidly obtain an ideal electrical diagram or one which is close to ideal. Such a processing method is generally carried out after a first organization of the data making it possible to list one or more electrical diagrams that one wishes to produce and before graphical plotting.

Stated otherwise, a method of graphical generation of an electrical diagram can comprise a step of implementing the method, such as described, for processing a set of data, and a step of graphical generation (that is to say of plotting on a page) of the electrical diagram of the electrical system on the basis of the data arising from said processing method (in particular the digital object aimed at hereinabove) by transmission of these data to a drawing device, in particular a device for digital paper printing in image form or in vector form.

All that has been stated hereinabove in conjunction with the invention allows a considerable time saving in the generation of an electrical diagram since the graphically generated diagram will directly be the appropriate one, notwithstanding minor modifications. Moreover, generating an appropriate positioning of the connectors makes it possible to improve the quality of the diagrams representing the electrical systems as well as their readabilities. Phases of studies have shown a non-negligible time saving of up to as much as 80%.

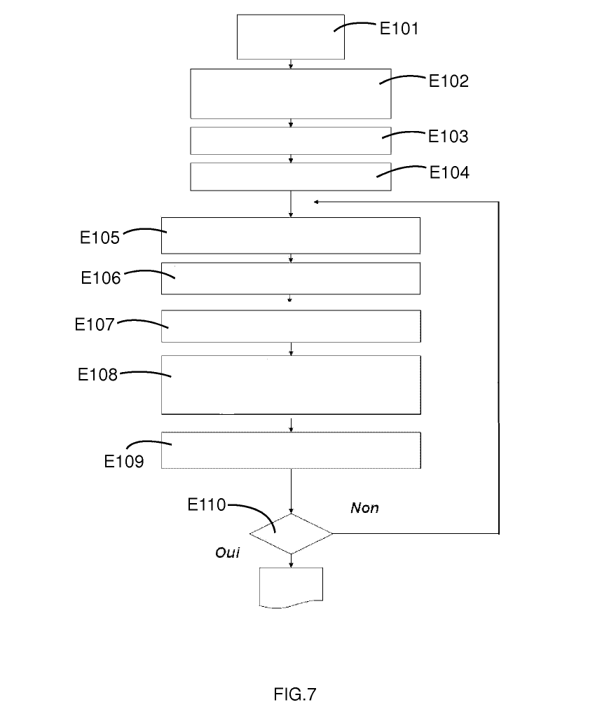

According to a particular example of the processing method illustrated in FIG. 7, the input data of the processing method are a list E101 of electrical systems and of their ins-outs, on the basis of these input data a library of models is created E102. Stated otherwise, each model can correspond to an electrical diagram. Each model comprises a list of identifiers of components and their positionings on the diagram to be generated. A correspondence E103 is established thereafter between each electrical system and a model, in particular to determine the configuration. Once this correspondence has been established, each electrical system will be processed E104 in the following manner:
the connectors are added E105 to the components, and the optional unions and splices in particular as a function of the input data,
the linking elements are added E106 between the connectors to mark the presence of an electrical signal between two connectors,
a weight is allotted E107 to each linking element, said weight being dependent on the ins-outs associated with the linking element,
the final positioning of the connectors is computed E108 by applying the first and second rules described in greater detail hereinabove,
each linking element is processed by deploying E109 the signals to be connected on the pins of each connector.

If the electrical system which has just been processed is the last then the method of processing the data set (YES output of step E110) is exited, otherwise we return on output to step E104 (NO output of step E110) so as to process a new data set associated with a new electrical diagram. Preferably, the electrical systems of the list are all different, for example the list can comprise systems that differ in function such as an airbag or a vehicle brake or systems that are similar in function such as two airbag systems but whose ins-outs are different. This makes it possible to avoid carrying out the same thing twice.

Preferably each component that we shall seek to draw is associated with a symbol. This symbol may comprise one or more positions of points of attachment each intended to receive a connector. The coordinates of these points of attachment can be computed as a function of the position of the corresponding component and of the shape of the associated symbol. Each symbol can be added to the digital object. A symbol can be associated with a dynamic creation mode or a predefined creation mode. The dynamic creation mode makes it possible to create the shape of the symbol at the moment of the graphical plotting of the electrical diagram whereas the predefined creation mode makes it possible to fetch an already drawn symbol from a database, in particular a library of symbols under the responsibility of a librarian. This makes it possible to avoid the unwieldy management of the so-called “standard” symbols in the database and to opt for dynamic creation except for the complex symbols containing complex internal drawings.

The invention also relates to a data recording medium readable by a computer, on which is recorded a computer program comprising computer program code means for the implementation of the steps of the processing method such as described or of the graphical generation method such as described.

The invention also relates to a computer program comprising a computer program code means suitable for carrying out the steps of a processing method such as described or of a graphical generation method such as described, when the program is executed by a computer.

Moreover, a method of maintenance of a device, in particular of an automotive vehicle, can comprise a step of hooking a diagnostic system up to the device, a step of identification of a failed electrical system of the device, a step of display, or of printing on paper, of the corresponding electrical diagram such as generated by the method of graphical generation of the electrical diagram.

1-11. (canceled)

12. A method for processing a set of data that can be used subsequently with a view to graphical generation of an electrical diagram of an electrical system, or of an electrical system for an automotive vehicle, the method comprising:
transmitting a model arising from a database to a computer, the model comprising a list of identifiers of components of the electrical system, and, for each component identifier, a position of the component on the electrical diagram to be generated;
determining, by the computer, a configuration of the electrical diagram to be generated, the configuration including a plurality of connectors;
associating, by the computer, with each component at least one connector of the plurality of connectors;
determining, by the computer, a topology of the electrical diagram to be generated, the topology comprising linking elements, each linking element linking at least two connectors.

13. The method as claimed in claim 12, wherein the configuration determined is chosen from among a plurality of configurations of the electrical diagram.

14. The method as claimed in claim 12, wherein the associating at least one connector with each component comprises positioning one or more connectors based on data arising from the topology determined and the model provided.

15. The method as claimed in claim 14, wherein the positioning, at a level of a component, of at least one of the connectors associated with one and a same linking element is carried out to minimize its length.

16. The method as claimed in claim 14, wherein a first linking element is associated with a first connector of a first component and with a second connector of a second component, and the positioning of the first connector at a level of the first component is carried out so that the distance between a first point of attachment of the first connector to the first component and a second point of attachment of the second connector to the second component is a minimum.

17. The method as claimed in claim 14, wherein:
a first linking element of a first weight is associated with a first connector of a first component and with a second connector of a second component;
a second linking element of a second weight is associated with the first connector of the first component and with a third connector of a third component;
the positioning of the first connector is carried out to minimize the length of the linking element whose weight is largest.

18. The method as claimed in claim 17, further comprising allotting a weight to each linking element, the allotted weight being equal to a number of ins-outs associated with the linking element, the number of ins-outs for each linking element being contained in the determined topology of the electrical diagram.

19. The method as claimed in claim 12, wherein two linking elements of the electrical diagram share a branch in common, and further comprising positioning at least one union configured to link, via associated branches, at least three corresponding connectors.

20. The method as claimed in claim 19, wherein the union is positioned to decrease the length of the branches associated with the union.

21. A method of graphical generation of an electrical diagram, comprising:
implementing the processing method as claimed in claim 12;
graphically generating the electrical diagram of the electrical system on the basis of data arising from the processing method by transmission of the data to a drawing device, or a device for paper or digital printing in image form or in vector form.

22. A non-transitory computer readable medium comprising a computer program comprising a computer program code for carrying out the method as claimed in claim 12, when the program is executed by a computer.
